(19) United States
(12) Patent Application Publication
(10) Pub. No.: US 2005/0139685 A1
(43) Pub. Date: Jun. 30, 2005

(54) Design & method for manufacturing low-cost smartcards with embedded fingerprint authentication system modules

(76) Inventor: Douglas Kozlay, Timonium, MD (US)

Correspondence Address: Douglas Kozlay;Suite 410, 9475 Deereco Road, Timonium, MD, 21093, US

(21) Appl. No.: 10/885,194

(22) Filed: Jul. 6, 2004

Related U.S. Application Data
(60) Provisional application No. 60/533,073, filed on Dec. 30, 2003.

(51) Int. Cl. G06K 19/06

(52) U.S. Cl. 235/492

(57) ABSTRACT

A method is disclosed for designing and manufacturing smartcards containing a low cost, embeddable, fully-integrated, fingerprint authentication system module. In a first preferred embodiment, the smartcard module contains a complete, unitary, autonomous data processing subsystem comprising a consolidated fingerprint authentication sensor including a data processor and memory; a power subsystem; and a smartcard interface subsystem. In a second preferred embodiment, the authentication system module of the present invention additionally contains an optional communication subsystem (e.g., ISO 14443 or other communication subsystem). The very small form factor of the enclosure for embedding the authentication system module provides a system module that is easily installed into an appropriate material substrate such as a smartcard body in a “one pass” automated insertion, saving manufacturing time, cost, and effort. This module can serve in any appropriate embedded application where speed and cost of manufacturing are of paramount importance.

### CROSS REFERENCE TO RELATED APPLICATIONS

This application claims the benefit of U.S. Provisional Application Ser. No. 60/533,073, filed on Dec. 23, 2003.

### BACKGROUND OF THE INVENTION

1. Field of the Invention

The field of the invention is the design, construction, and manufacturing of low-cost smartcards. The field of the invention is also design, construction, and manufacturing of advanced authentication system modules for smartcards, credit cards, debit cards, other card-based devices, and other embedded devices and applications.

1. Related Art

U.S. Pat. No. 4,582,985 to Lofberg discloses a data carrier with electrical contacts, preferably in the form of a smart card, with processor, memory and a sensing surface that can internally verify the fingerprint of the owner and enable access to cardholder information. The Lofberg patent does not address the design and construction of the card, however, and it is silent on the topic of low cost, efficient, effective installation of authentication system modules in smartcards, unlike the present invention. The authentication system module of the present invention, however, is conducive to high mobility and is also adapted for energetic handling, extreme flexibility and use with smartcard readers that require full card insertion.

U.S. Pat. No. 6,325,285 to Baratelli discloses a smart card with integrated fingerprint reader similar to that of the Lofberg patent, above. The Baratelli patent does not address the design and construction of the card, however, and it is silent on the topic of low cost, efficient, effective installation of authentication system modules in smartcards. The authentication system module of the present invention, however, is conducive to high mobility and is also adapted for energetic handling, extreme flexibility and use with smartcard readers that require full card insertion.

U.S. Pat. No. 6,249,052 to Lin discloses a substrate-on-chip MCM (Multi-Chip-Module) with CSP-(Chip-Size-Package) ready configuration. The invention also includes an integrated MSOCM (Multiple-Substrate-On-Chip-Module) assembly. This assembly includes a CSP-ready MSOCM board having a top surface and a bottom surface. The CSP-ready MCM includes a plurality of bonding-wire windows and the bottom surface includes board bonding pads near the bonding-wire window. The assembly further includes an adhesive layer disposed on top of the CSP-ready MCM board having also a plurality of bonding wire windows corresponding to and aligned with the bonding wire windows on the MCM board. The assembly also includes a plurality of integrated circuit (IC) chips mounted onto the adhesive layer over the top surface of the CSP-ready MCM board. Each of the IC chips is provided with a plurality of chip bonding pads facing an open space defined by the bonding wire windows. The assembly further includes a plurality of bonding wires disposed in the space defined by the bonding wire windows and interconnected between each of the chip bonding pads and a corresponding board bonding pad disposed on the bottom surface of the CSP-ready MSOCM board. The Lin patent discloses a useful invention related to certain technologies for constructing MCMs (multi-chip modules). However, there is no technology disclosed related to low cost, efficient, effective installation of authentication system modules in smartcards, unlike the present invention. The authentication system module of the present invention is conducive to high mobility, as it can be installed into standard credit cards, debit cards, or smartcard devices, and thereby snugly and securely fit into wallets, pockets, etc.

U.S. Pat. No. 5,949,142 to Otsuka discloses a chip size package and method of manufacturing the same. A chip size package is constituted by a chip on which an integrated circuit is formed, and plated bumps are formed at terminal portions of the integrated circuit, a flexible two-layered printed-circuit board having inter-level conductive bumps for electrically connecting metal patterns formed on the two surfaces of the flexible board, an anisotropic conductive film for electrically connecting the plated bumps arranged on the chip to the flexible two layered printed circuit board, and fixing the chip onto the flexible two layered printed circuit board. While the patent to Otsuka provides utility for his intended applications, Otsuka is silent on the topic of low cost, efficient, effective installation of authentication system modules in smartcards, unlike the present invention. The “unitary” authentication system module of the present invention is conducive to high mobility and is also adapted for energetic handling and extreme flexibility.

U.S. Pat. No. 5,909,010 to Tatsuo teaches a CSP which includes a semiconductor IC chip having I/O terminals along its edges. A small size substrate has a smaller contour than the chip and has a plurality of metal terminals arranged along the edges of its bottom, and metal bumps in a lattice configuration. The top of the chip and bottom of the substrate are so configured as to be electrically connected to each other via tape member including a plurality of leads. These leads each include a first terminal to be electrically connected to the associated I/O terminal of the chip, and a second terminal to be electrically connected to the associated metal terminal of the substrate. Tatsuo is silent of the topic of low cost efficient, high-volume installation of “unitary” authentication system modules, using a “one pass automated insertion”, unlike the present invention.

U.S. Pat. No. 5,703,753 to Mok discloses an electronic assembly, and a mounting assembly for an MCM module or other circuit module, which includes a board having a surface including an array of board contacts, such as a printed wiring board in a computer system. A circuit module such as the MCM module, having a first surface and a second surface is included. The circuit module includes an array of circuit contacts on the first surface of the circuit module. An interposer between the board and the first surface of the circuit module includes conductors between the circuit contacts in the array of circuit contacts on the circuit module and board contacts in the array of board contacts on the board. Other enabling interconnections are disclosed. Notwithstanding the value of the patent for products in Mok's intended technical area, there is no mention of providing a method to facilitate low cost manufacturing of smartcards by means of efficient, effective installation of “unitary” authentication system modules into smartcards, unlike the present invention. U.S. Pat. No. 6,655,585 to Shinn teaches a system and method for authenticating a smart card user at a reader device, which uses an application on a smart card microprocessor on which information fields relating to biometric information for the user and a table of pre-defined probability of occurrence values for user authentication is stored. The smart card and biometric sample for the user is presented to reader device, and an application associated with the reader device automatically authenticates the user based on match level between the stored biometric information and the presented biometric sample presented according to a desired probability of occurrence value from the table. Alternatively, the user is automatically authenticated by an application on the smart card microprocessor. The reader device reads the presented biometric sample, automatically presents what is read to the smart card application and the smart card application then authenticates the user according to the threshold match score from the stored table that corresponds to the desired probability of occurrence value. While Shinn's patent provides utility for intended applications, it is silent on the topic of low cost, efficient, effective installation of “unitary” authentication system modules in smartcards, unlike the present invention. The authentication system module of the present invention is conducive to high mobility and is also adapted for energetic handling and extreme flexibility.

### OBJECTS OF THE INVENTION

One object of this invention is to provide a small form factor, self-contained, autonomous, independent, single module-based, “unitary” authentication system module-based fingerprint biometric device at low cost, which eliminates “non-pre-assembled” discrete parts and interconnections. Another object is to design it so that it can be mass produced more simply using only slightly modified versions of many existing smartcard module insertion machines, enabling mass production on a greater scale. A third object is to eliminate the extended, sometimes fragile and/or “labyrinthine” interconnecting wiring and connections which represent important points of failure in smartcards that will be routinely bent and roughly handled in normal use. Accordingly, the unitary authentication system module apparatus of the present invention results in cards that are practical to distribute and support in mass markets. A fourth object is to provide a card that can be swiped with a finger before the card is inserted into a card reader, thereby enabling a biometric card to be used with full-insertion (“full dip”) smartcard readers that block access to the sensor after card insertion.

### DRAWINGS—FIGURES

FIG. 1a, Prior Art—Conventional Fingerprint Enabled Smartcard

FIG. 1b, Smartcard Module with Fully Integrated Fingerprint System

FIG. 2, Finger Swiping Smartcard Module with Fully Integrated Fingerprint System

FIG. 3, Explosion Drawing Showing the Assembly of Components into a Complete Module

FIG. 4, Smartcard Module with Fully Integrated Fingerprint Authentication System

FIG. 5, Cross Section A-A of Smartcard Module with Fully Integrated Fingerprint System

### DRAWINGS—REFERENCE NUMERALS

2—Plastic smartcard
4—Module containing fingerprint sensor, processor and smartcard contacts
6—Finger swiping the sensor
8—Opening in substrate for finger access
10—Module substrate with printed circuitry
12—Fingerprint swipe sensor and processor die
14—Smartcard contacts
15—Ball or other connections between electronic components and substrate circuitry
16—Thin Battery or Capacitor
18—Optional RF Antenna
20—Optional LED Indicators
21—Optional Sound Generator
22—Finger Sliding Guides

### DESCRIPTION OF THE INVENTION

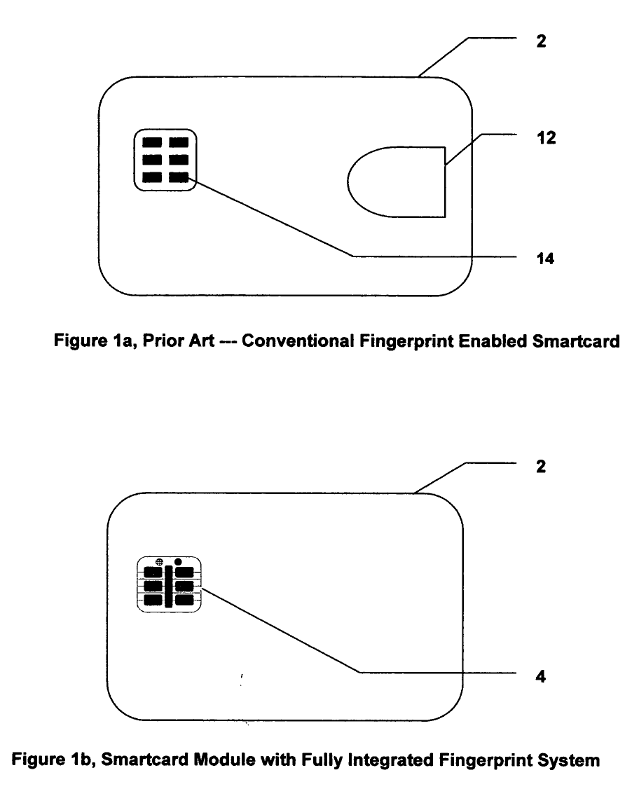

As shown in FIG. 1a, fingerprint-enabled smartcards 2 that have been manufactured prior to this invention are typically designed with a fingerprint sensor 12 on one side of the card and smartcard contacts 14 on the other side of the card. This permits the cardholder to insert the card in a card reader that has a small insertion depth such that the fingerprint sensor remains exposed to enable finger contact, using the smartcard module contacts to obtain power from the reader while the fingerprint authentication process is executed.

The biometric smartcard of the present invention, shown in FIG. 1b, is a complete fingerprint biometric authentication system contained completely within one single, fully integrated “unitary” electronic authentication system module 4 adapted for low-cost, high-volume, automated, “one pass” automated insertion into the smartcard substrate 2 using existing smartcard automation techniques. The present invention illustrated in FIG. 1b, uses a small battery or capacitor 16 to operate the fingerprint processing electronics before the card is inserted into the card reader, in order to achieve several advantages as noted above in Objects of the Invention. To technically overview the present invention, the authentication system module contains all necessary enabling components: a plastic card substrate; a data processing subsystem with a consolidated data processor and fingerprint sensor with a non-volatile memory; a power subsystem including either a battery and/or a capacitor with optional recharging capability; a smartcard interface subsystem with “multi-functional” smartcard contacts (which can optionally serve as recharging contacts); an optional communications subsystem including components and antenna; and all necessary interconnections and component bonding—all within one single, flat, fully self-contained module 4. The preferred form factor of the system module is coin-shaped, approximately 1/32-inch thick (about the thickness of a credit card) and has a small diameter (about the width of a US quarter coin). The preferred “unitary”, fully integrated authentication system module optimally has only one external connector, to simplify embedding it in larger devices (e.g., plastic credit cards, debit cards, or smartcard bodies).

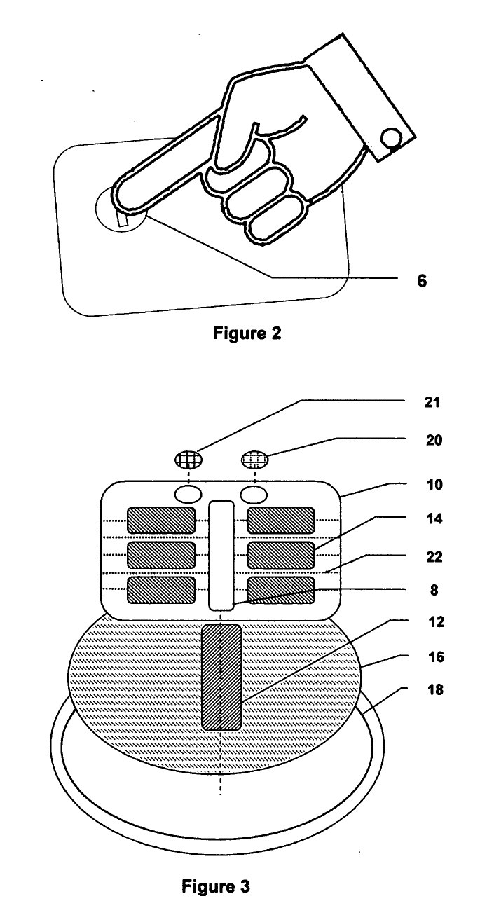

In operation, the enrolled and authenticated smartcard user's fingerprint (not shown) is read by swiping at least one user's human finger 6 over the sensor portion of the top surface of the embedded authentication module, as shown in FIG. 2.

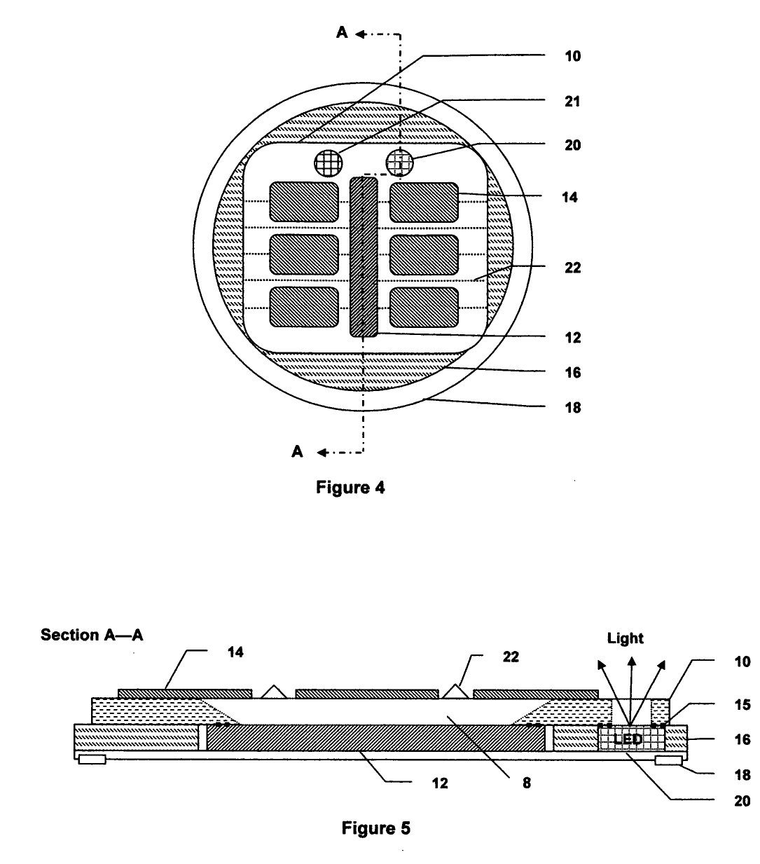

More specifically, the authentication system module 4 includes a complete fingerprint biometric authentication system. Appropriately named an “authentication system module”, the module has the inherent, self-contained, autonomous capacity to authenticate one or more users. For each user, at least one finger (and accordingly, at least one fingerprint per each user) can be enrolled for later authentication. The single ASIC (application specific integrated circuit)-based “authentication system module” further comprises a data processing subsystem including a consolidated fingerprint authentication sensor and data processor (e.g., microprocessor) including sufficient memory to hold fingerprint templates, fingerprint matching software, and software for “contact” interface with conventional card readers and for “contactless” interface with conventional card readers and/or custom smartcard readers. During manufacturing, the module can be relatively easily and expeditiously inserted into a plastic smartcard body or other card body composed of PVC or other suitable plastic as shown in FIG. 1b. According to the preferred design of the present invention, there are no external electrical connections outside of module 4 except those of smartcard electrical contacts 14 on its surface and an optional connection to an integrated radio frequency antenna 18. The resulting smartcard can be mechanically and electrically compliant with the international ISO 7816 smartcard standard, or alternatively configured to any other desired standard. The entire system is manufactured on a substrate such that the module is the thickness of a credit card (about 1/32 inch). The preferred embodiment of FIG. 4 is less than 3/4 inch (2 cm) in diameter. As illustrated in FIG. 4, the module includes a fingerprint sensor and processor chip which may be combined in the same silicon die 12, smartcard electrical contacts 14, a battery or capacitor 16, an optional RF antenna 18, and optional LED indicator 20 or sound generator 21. The preferred assembly order of these components is illustrated in the explosion drawing, FIG. 3.

As illustrated in FIG. 5, the view of the Cross Section A-A of FIG. 4 (and other figures in various views), the biometric authentication system module is composed of a stiff but flexible insulating substrate 10, on which the electrical smartcard contacts 14, and internal circuit traces (not shown) are deposited or etched. These contacts provide one possible communication path to terminal or computer devices by means of a smartcard reader and the same power contacts can also provide power when so connected to recharge the battery 16. The smartcard contact mechanism is well known to the art and is described in the ISO/IEC 7816 standard. Under the substrate 10 and between or adjacent to the contacts 14 is placed an integrated circuit die(s) 12 that provides the fingerprint sensing and processing functions as described below. Interconnects between the component and the substrate may be made by any of the “flip-chip” or “wire-bonding” techniques used to attach silicon components to printed circuits that are well known to the art. The sensor portion of the die surface is exposed to the top surface of the module so that a human finger 6, swiped across the die can be authenticated by the sensor and processor 12. The die may also have a coated surface to protect its exposed surface from damage. The fingerprint sensor swiping technique is well known to the art and is taught in other patents or applications such as EP1330185.

The module has an array of ridges or grooves on either side of the sensor arranged in a common direction so as to provide a tactile finger sliding guide, 22, which causes the finger to move in a consistent direction each time that it is swiped. These grooves are of sufficiently low profile to enable them to easily enter the slot in conventional smartcard readers. The fingerprint authentication sensor/data processor die 12 is protected from wear by covering its edges, recessing the surface below that of the top of the module, and applying a plastic coating to its surface by conventional coating means.

Smartcard contact use and signaling are well known to the art and are described in the international ISO/IEC 7816 standard. Optionally, the communication subsystem transmission mechanism required to authenticate the user can be contactless (vicinity, proximity, etc.), performing the communications by a radio frequency or IR link. Such links are well known to the art and are described in standards such as ISO/IEC 14443 using an antenna loop 18 which can also reside on the substrate 10. Also, optionally, one or more LEDs can be mounted to the module substrate 20 to light green, for example, to indicate positive biometric authentication (or red, indicating authentication failure). Alternately, authentication events can be indicated, e.g., by means of a sound generator 21 which produces a beep or other audible sound.

### EXAMPLES OF USE

New cards would typically issued by a bank, employer, or other organization. “Enrollment of authorized individuals to the card can take place by swiping a fingerprint on the card and then using a computer with a security mechanism (e.g., a special authorization code to program the card) in order to restrict enrollment and issuance to the authorized cardholder. A new card is enrolled” by sliding a fingertip 6 across the sensor of FIG. 2, guided by the finger sliding guides 22 of FIG. 5 that cause the finger to move across the sensor in a straight line in a consistent direction. Power for the sensor/processor circuit is provided by the power subsystem (e.g., battery and/or capacitor) which is optionally recharged when the card is inserted into a smartcard reader. In this case, power is taken from the card's power and ground contacts 14 and directed to the battery by a charging circuit well known to the art. If an acceptably intact and properly oriented fingerprint is scanned, then a template that represents the user's fingerprint is generated by a program in the processor. The processor then activates an indication (e.g., visual and/or audible) by means of the optional LED display 20, or an optional sound generator 21, to indicate to the enrollee person swiping the finger, that their enrollment was successfully accomplished. The template is internally stored in the nonvolatile memory of the sensor/processor 12 subsystem. At enrollment time, additional fingers may then be enrolled. After the desired number of fingers have been enrolled, the card is locked so as to prevent the introduction of additional fingerprint templates and is available for use.

To use the card 2, the cardholder swipes a finger 6 across the sensor 12 using the fingerprint sliding guides 22 to cause the finger to traverse the sensor in the approximately same direction that was used to enroll the finger. The battery or capacitor provides a power source during authentication and communication. The sensor and processor chip produces a fingerprint template as taught by EP1330185 and others and compares it with the templates that permanently remain in nonvolatile processor memory from the enrollment process. If the match meets the threshold of acceptability as described in EP1330185, then the authentication is accepted and a confirming messages is sent to the computer via a combination of one or more of the smartcard contacts, the optional RF link and associated transceiver, and/or the optional LED

1. A smartcard apparatus comprising a unitary authentication system module adapted for low cost manufacturing by means of one-step automated insertion into a smartcard body, further comprising a data processing subsystem comprising a fingerprint authentication subsystem including a data processor and a memory, and additionally comprising a power subsystem, a smartcard reader interface subsystem, and an optional communications subsystem.

2. The smartcard apparatus of claim 1, wherein said power subsystem comprises a battery adapted for automatic recharging upon insertion into a smartcard reader.

3. The smartcard apparatus of claim 2, wherein said battery adapted for automatic recharging is recharged by means of multi-functional smartcard contacts further adapted for recharging said power subsystem comprising said battery.

4. The smartcard apparatus of claim 1, wherein said power subsystem comprises a capacitor adapted for automatic recharging upon insertion into a smartcard reader.

5. The smartcard apparatus of claim 4, wherein said capacitor adapted for automatic recharging is recharged by means of multi-functional smartcard contacts further adapted for recharging said power subsystem comprising said capacitor.

6. The smartcard apparatus of claim 1, where said smartcard further comprises a communications subsystem comprising a radio-frequency transceiver and antenna for contactless use.

7. A method for manufacturing low cost smartcards, comprising the steps of:
a. manufacturing a unitary authentication system module, and
b. inserting said unitary authentication system module into a smartcard body by means of a one pass automated insertion operation to complete manufacturing of said smartcard.

8. The unitary authentication system module of claim 1, wherein said subsystem is further adapted to authenticate at least one human finger and provide at least one of an audible and a visual indication to indicate authentication of said at least one human finger.

9. The unitary authentication system module of claim 1, wherein said subsystem is adapted to perform autonomous authentication of at least one human fingerprint.

10. The unitary authentication system module of claim 1, wherein said authentication system module is adapted for improving the swiping of a human finger thereupon by means of finger sliding guides.

11. The unitary authentication system module of claim 1, wherein the fingerprint sensor is situated in between smartcard contacts.

12. The unitary authentication system module of claim 1, wherein the fingerprint sensor is situated adjacent to smartcard contacts.

13. The unitary authentication system module of claim 1, wherein said unitary authentication system module is adapted to authenticate at least one human fingerprint to enable said smartcard apparatus prior to insertion into a “full dip” smartcard reader apparatus.

14. A method for enabling smartcards, comprising the step of authenticating the fingerprint of an enrolled user to enable said smartcard prior to insertion, and the step of inserting said smartcard into said smartcard reader after enablement for “contact interface”.

15. The method of claim 14, wherein the step of inserting said smartcard into said smartcard reader after enablement for “contact interface”, is replaced by the step of said smartcard wirelessly communicating after enablement with said smartcard reader for “contactless interface”.
